(19) United States
(12) Patent Application Publication
(10) Pub. No.: US 2006/0280316 A1
(43) Pub. Date: Dec. 14, 2006

(54) AUDIO SYSTEM AND METHOD FOR CONTROLLING AN AUDIO SYSTEM

(75) Inventor: David Joseph Prince, Villa Park, IL (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/160,119

(22) Filed: Jun. 9, 2005

(51) Int. Cl. H04B 1/00

(52) U.S. Cl. 381/86; 381/98; 381/104

(57) ABSTRACT

An audio system includes a first speaker operable to output sound over a first frequency range, and a second speaker operable to output sound over a second frequency range. A first input device is operable to select a volume of the sound output by the first and second speakers, and a second input device is operable to effect a change in the volume of the sound output by the first and second speakers, independently of each other. A control system is configured to effect a change in the volume of the sound output by the second speaker over a high portion of the second frequency range, while holding substantially constant the volume of the sound output by the second speaker over a low portion of the second frequency range, when the second input device is operated to change the volume of the sound output by the second speaker.

### BACKGROUND OF THE INVENTION

1. Field of the Invention

The present invention relates to an audio system, and a method for controlling an audio system.

2. Background Art

Audio systems having more than one speaker are often divided into front and rear zones controlled by a fade switch, which may be actuated by a knob, pushbutton, or other input device. In such a system, the fade control changes the relative volume of the playback between the front and rear speakers. The term “fade forward” describes a situation wherein the front speakers produce a higher level of sound than the rear speakers. The term “fade rearward” indicates the opposite.

In some audio systems, there may be a difference between the front speakers and the rear speakers. For example, in a vehicle where space is at a premium in the front of the passenger compartment, smaller speakers may be used than in the rear. Because the size of the speakers typically determines the usable frequency response for a given efficiency, the larger speakers in the rear may be capable of reproducing lower frequencies than the smaller speakers in the front of the vehicle. In such a situation, a fade forward to the smaller speakers in the front of the vehicle results in a loss of bass or lower frequencies of the audio playback. This can cause the sound to appear “thin” or “without body”.

It would therefore be desirable to have an audio system and a method for controlling an audio system which can provide sound output in a fade condition to a first speaker or speakers with little or no loss of bass frequencies, even when the first speaker or speakers have less bass response than the other speakers.

### SUMMARY OF THE INVENTION

Accordingly, an embodiment of the present invention provides an audio system having at least one speaker capable of reproducing lower frequency sounds than at least one other speaker. The audio system is configured such that when it is controlled to fade to the higher frequency speaker or speakers, there is little or no loss of bass frequency response.

The invention also provides an audio system, including a first speaker operable to output sound over a first frequency range, and a second speaker operable to output sound over a second frequency range. A first input device is operable to select a volume of the sound output by the first and second speakers. A second input device is operable to effect a change in the volume of the sound output by the first speaker over at least a portion of the first frequency range separately from the volume of the sound output by the second speaker. The second input device is further operable to effect a change in the volume of sound output by the second speaker over at least a portion of the second frequency range separately from the volume of the sound output by the first speaker. A control system, including at least one controller, is in communication with the first and second speakers, and the first and second input devices. The control system is configured to effect a change in the volume of the sound output by the second speaker over a high portion of the second frequency range when the second input device is operated to effect a change in the volume of the sound output by the second speaker. The change in volume of the sound output by the second speaker over the high portion of the frequency range occurs while the volume of the sound output by the second speaker over a low portion of the second frequency range is held substantially constant.

The invention further provides an audio system for a vehicle, including a first speaker operable to output sound over a first frequency range, and a second speaker operable to output sound over a second frequency range. A volume control selector is operable to select a volume of the sound output by the first and second speakers. A fade control selector is operable to facilitate a change in the volume of the sound output by either one of the speakers independently of the volume of the sound output by the other one of the speakers. A filter is disposed between the fade control selector and the second speaker, the filter being configured to keep the volume of the sound output by the second speaker substantially constant over a low portion of the second frequency range, when the fade control selector is operated to facilitate a change in the volume of the sound output by the second speaker. The filter is also configured to facilitate a change in the sound output by the second speaker over a high portion of the second frequency range, when the fade control selector is operated to facilitate a change in the volume of the sound output by the second speaker.

The invention also provides a method for controlling sound output by an audio system having first and second speakers. The first speaker is operable to output sound over a first frequency range, and the second speaker is operable to output sound over a second frequency range. The method includes setting a volume of the sound output by the first speaker, and setting a volume of the sound output by the second speaker. The method further includes reducing the volume of the sound output by the second speaker over a high portion of the second frequency range while holding substantially constant the volume of the sound output by the second speaker over a low portion of the second frequency range.

### BRIEF DESCRIPTION OF THE DRAWINGS

FIG. 1 is a top plan view of a vehicle having an audio system in accordance with an embodiment of the present invention;

FIG. 2 is a simplified schematic drawing of a portion of the audio system shown in FIG. 1, including a control system;

FIG. 3 is a graph showing rear channel signal processing for a fade forward condition for the audio system shown in FIGS. 1 and 2;

FIG. 4 is a graph showing rear channel signal processing for a balanced front and rear condition for the audio system shown in FIGS. 1 and 2;

FIG. 5 is a graph showing rear channel signal processing for a fade rearward condition for the audio system shown in FIGS. 1 and 2; and

FIG. 6 is a simplified schematic drawing showing a portion of an alternative embodiment of the present invention.

### DETAILED DESCRIPTION OF THE PREFERRED EMBODIMENT(S)

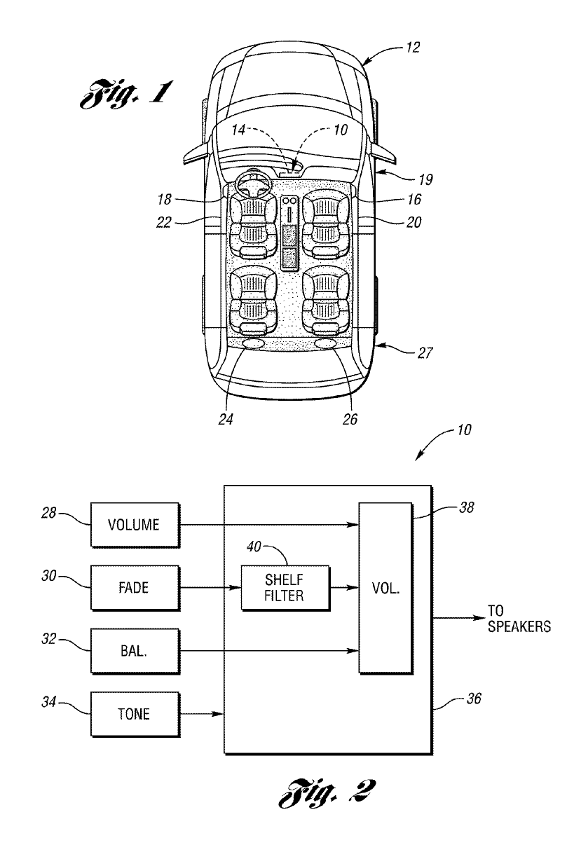

FIG. 1 shows an audio system 10 in accordance with an embodiment of the present invention. The audio system 10 is installed in a vehicle 12, and includes a control panel 14, which may have any number of input devices including knobs, buttons, or other actuators to allow a vehicle occupant to operate the audio system 10. Moreover, input devices for the audio system 10 may also include one or more sensors, configured to receive signals from a remote control device. The audio system 10 may also include one or more media players, such as a tape deck, a compact disc (CD) player, and/or a digital versatile disc (DVD) player.

The audio system 10 includes a pair of first speakers, or front speakers 16, 18. Although the audio system 10 is shown having two front speakers 16, 18, it is understood that it may have a single front speaker, or more than two front speakers, as desired. The front speakers 16, 18 are located in a front portion 19 of the vehicle 12 in respective trim components, and in particular, in door panels 20, 22. It is understood that such speakers may be located in other trim components, such as an instrument panel, headliner, or in other locations in the vehicle 12.

As shown in FIG. 1, the audio system 10 also includes a pair of second speakers, or rear speakers 24, 26, located in a rear portion 27 of the vehicle 12. The front speakers 16, 18 are operable to output sound over a first frequency range through a front channel of the audio system 10, and the rear speakers 24, 26 are operable to output sound over a second frequency range through a rear channel of the audio system 10. The first and second frequency ranges may be coincident, although in some vehicle applications, the second frequency range will have a lower limit than the first frequency range. Similarly, an upper limit of the first frequency range may be higher than an upper limit of the second frequency range. As explained more fully below, the audio system 10 is configured such that when an operator chooses a fade forward condition, the rear speakers 24, 26 still provide at least some low frequency bass response, thereby providing a sound within the vehicle 12 that avoids the “thin” sound associated with the use of only high frequency speakers.

FIG. 2 shows a simplified schematic drawing of a portion of the audio system 10. A first input device, or volume control 28, is operable to select the volume of the sound output by the speakers 16, 18, 24, 26. A second input device, or fade control selector 30, is operable to effect a change in the volume of the sound output by the front speakers 16, 18 separately from the volume of the sound output by the rear speakers 24, 26. The fade control selector 30 is also operable to effect a change in the volume of the sound output by the rear speakers 24, 26 independently of the sound output by the front speakers 16, 18. Additional input devices include a balance selector 32, used to choose between left and right channels, and a tone selector 34, used to choose various frequencies. Each of the input devices 28, 30, 32, 34 can include knobs, buttons, or other devices which can be operated by a vehicle occupant to effect the desired control of the audio system 10. Moreover, one or more of the input devices 28, 30, 32, 34 may also, or alternatively, be capable of actuation by a remote control device. It is worth noting that although the audio system 10 is shown in FIG. 1 installed in the vehicle 12, audio systems in accordance with the present invention are not limited to vehicle audio systems, and rather, may be installed in other settings, including homes, offices, and other spaces.

As shown in FIG. 2, each of the input devices 28, 30, 32, 34 provides input into an audio system controller 36. The audio system controller 36 may include various electronic circuits and other hardware and/or software effective to control the sound output by the audio system 10. Within the audio system controller 36 is a separate volume controller 38. The volume controller 38 receives inputs from the volume control selector 28, the fade control selector 30, and the balance control selector 32.

Each of the inputs 28, 30, 32 facilitates a change in the volume of the sound output by one or more of the speakers 16, 18, 24, 26. For example, the volume control selector 28 can be used to selectively increase or decrease the volume of the sound output by all four speakers 16, 18, 24, 26, simultaneously. Of course, whether any of the given speakers 16, 18, 24, 26 is outputting sound, may depend on the settings of the fade control selector 30 and the balance control selector 32. The balance control selector 32 allows an operator to selectively choose between the driver side speakers 18, 24 and the passenger side speakers 16, 26. For example, as the balance control selector 32 is moved from a middle position toward the driver side speakers 18, 24, the volume of the sound output by the passenger side speakers 16, 26 will decrease. Depending on the configuration of the audio system controller 36, the volume of the sound output by the driver side speakers 18, 24 may remain constant as the passenger side volume decreases, or alternatively, the driver side volume may increase as the passenger side volume decreases.

In contrast to the balance control selector 32, which chooses between the left and right channels, the fade control selector 30 allows an operator to independently control the volume of the sound output by the front speakers 16, 18, and rear speakers 24, 26. The fade control selector 30 allows the volume of the sound output by the front speakers 16, 18 to be controlled separately, or independently from the volume of the sound output by the rear speakers 24, 26. It is worth noting that as used herein, the terms “separate” or “independent” control of different speakers or speaker sets, does not necessary imply that as the sound in one speaker or speaker set is adjusted there is no change in the sound of the other speaker or speakers. For example, adjusting the fade control selector 30 to a fade rearward condition will decrease the volume of the sound output by the front speakers 16, 18. At the same time, the volume of the sound output by the rear speakers 24, 26 may stay constant, or it may increase, depending on how the audio control system 36 is configured. Therefore, the “separate” or “independent” control of the front speakers 16, 18 and the rear speakers 24, 26 by the fade control selector 30, merely implies that an adjustment of the fade control selector 30 does not affect the front speakers 16, 18 in the same way that it affects the rear speakers 24, 26, and indeed, it may not affect one of the sets of speakers at all.

In addition to the separate volume controller 38 within the audio control system 36, there is also a shelf filter 40 disposed between the fade control selector 30 and the volume controller 38. As known to those in the art, a shelf filter is one that has a flat filter response in a lower frequency region, and another flat filter response in an upper frequency region, with a sloping transition region bridging the two. Typically, one of the flat sections is fixed, so that, for example, a high shelf filter would keep the low frequency section constant, and adjust the high frequency section. Conversely, a low shelf filter would keep the high frequency section constant, while adjusting the lower frequency section only. As discussed above, when an operator actuates the fade control selector 30 to a fade rearward condition, the volume of the sound output from the front speakers 16, 18 is reduced. In particular, it is reduced over the entire first frequency range.

In contrast, the use of the shelf filter 40 modifies a fade forward condition, such that the sound output by the rear speakers 24, 26 is reduced only over a high portion of the second frequency range. For example, FIG. 3 shows an output of the audio system 10, and in particular, a rear channel signal processing for a fade forward condition. As shown in FIG. 3, the volume output (shown in decibels along the ordinate) is approximately constant over a low frequency range up to some predetermined frequency (f₁). Over the low portion 42 of the second frequency range, the rear speakers 24, 26 maintain an approximately constant volume output, despite actuation of the fade control selector 30 to a fade forward condition.

Also shown in FIG. 3 is the volume output for an upper portion 44 of the second frequency range. Because the audio system 10 is in a fade forward condition, the volume output over the upper portion 44 of the second frequency range is extremely low. Thus, when the audio system 10 is in the fade forward condition, sound will be output from the front speakers 16, 18 over the entire first frequency range; whereas, the sound output from the rear speakers 24, 26 will include only frequencies in the lower portion 42 of the second frequency range. This helps to ensure that an occupant of the vehicle 12 will perceive a “full” sound even when the audio system 10 is adjusted to a fade forward condition. Moreover, because human perception of low frequencies is generally non-directional, occupants of the vehicle 12 will generally not notice that the lower frequency sounds are emanating from the rear speakers 24, 26. Thus, it may appear to a vehicle occupant listening to the audio system 10 in a fade forward condition, that a full frequency range of sound is provided by the front speakers 16, 18.

The shelf filter 40 can be configured such that a desired value of the predetermined frequency (f₁) can be used. For example, it may be desirable to choose a value of (f₁) of approximately 80 Hertz (Hz), such that the lower portion 42 of the second frequency range only includes frequencies below 80 Hz. The actual selection of the frequency (f₁) may depend on a number of factors, including the particular vehicle, or other space, into which an audio system in accordance with the present invention is installed. The selection of the frequency (f₁) can also depend on which frequencies are included in the first or second frequency range. For example, the first and second frequency ranges may be chosen such that the entire lower portion 42 of the second frequency range is below the first frequency range.

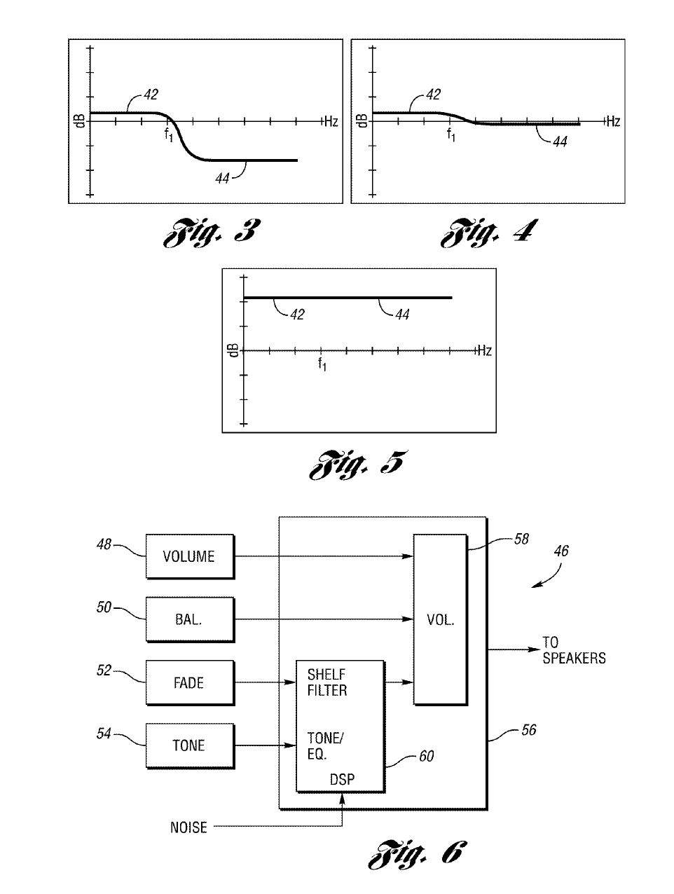

In contrast to FIG. 3, which showed a full fade forward condition, shows the rear channel signal processing for an approximately even distribution of sound throughout the vehicle 12. As shown in FIG. 4, the volume of the upper portion 44 of the second frequency range has been increased significantly as compared to FIG. 3. The upper portion 44 of the second frequency range still has a lower volume than the lower portion 42, since the front speakers 16, 18 lack the low frequency response of the rear speakers 24, 26. As discussed above, the fade control selector 30 can be adjusted such that the audio system 10 is in a full fade rearward condition, if so desired.

FIG. 5 shows the rear channel signal processing for the fade rearward condition. As shown in FIG. 5, the volume output over the entire second frequency range is approximately constant, with the lower portion 42 matching the output of the upper portion 44. It is worth noting that the decibel level of the lower portion 42, as shown in FIG. 5, is greater than its level in FIGS. 3 and 4. This can be the result of an increase in the overall volume, as controlled by the volume control selector 28, or alternatively, the audio system controller 36 can be configured such that moving the fade control selector 30 to the rear speakers 24, 26 will not only reduce the volume of the sound output by the front speakers 16, 18, but will simultaneously increase the volume of the sound output by the rear speakers, 24, 26. In such a configuration, moving the fade control selector 30 to the front speakers 16, 18, would increase the volume of the sound output by the front speakers 16, 18, as the volume of the sound output by the rear speakers 24, 26 decreased—at least over the upper portion 44 of the second frequency range.

As noted above, FIG. 2 shows a simplified schematic drawing of one embodiment of the present invention. It will be appreciated by those skilled in the art that many variations of the embodiment shown in FIG. 2 are contemplated within the present invention. For example, FIG. 6 shows a portion of an audio system 46 in accordance with another embodiment of the present invention. A volume control selector 48, a balance control selector 50, a fade control selector 52, and a tone control selector 54, provide inputs into an audio control system 56. Similar to the audio control system 36, shown in FIG. 2, the audio control system 56 includes a separate volume controller 58. The audio control system 56, is slightly more complex, in that it includes a digital signal processor (DSP) 60 which may be configured with control hardware and/or software as shown in FIG. 6. For example, the DSP 60 includes a shelf filter and a tone/equalizer control which can be utilized by the fade control selector 52 and the tone control selector 54, respectively. Moreover, the DSP 60 provides filter for noise which may be caused by components within the audio system 46 itself, or may result from surrounding electronic devices, such as those found in a vehicle instrument panel.

The audio system 46 may be controlled in a method similar to that of the audio system 10, shown in FIG. 2. For example, if the audio system 46 were installed in the vehicle 12, the volume control selector 48 could be used to set the volume output of both the front speakers 16, 18 and the rear speakers 24, 26. The fade control selector 52 could then be used to reduce the volume of the sound output by the rear speakers 24, 26 over the upper portion 44 of the second frequency range, while holding substantially constant the volume of the sound output by the rear speakers 24, 26 over the lower portion 42 of the second frequency range. As discussed above, this is accomplished through the use of a shelf filter, which in the embodiment shown in FIG. 6, is integrated into the DSP 60. Thus, the audio system 46 also allows an operator to adjust the fade control selector 52 to a full fade forward position, while still providing sound to the vehicle occupants over a full frequency range from the low limit of the second frequency range to the upper limit of the first frequency range.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An audio system comprising:
a first speaker operable to output sound over a first frequency range;
a second speaker operable to output sound over a second frequency range;
a first input device operable to select a volume of the sound output by the first and second speakers;
a second input device operable to effect a change in the volume of the sound output by the first speaker over at least a portion of the first frequency range separately from the volume of sound output by the second speaker, and further operable to effect a change in the volume of sound output by the second speaker over at least a portion of the second frequency range separately from the volume of the sound output by the first speaker; and
a control system including at least one controller, the control system being in communication with the first and second speakers and the first and second input devices, the control system being configured to effect a change in the volume of the sound output by the second speaker over a high portion of the second frequency range when the second input device is operated to effect a change in the volume of the sound output by the second speaker, while holding substantially constant the volume of the sound output by the second speaker over a low portion of the second frequency range.

2. The audio system of claim 1, wherein the low portion of the second frequency range includes only frequencies below 80 Hertz.

3. The audio system of claim 1, wherein the control system is further configured to effect a change in the volume of the sound output by the first speaker over the first frequency range when the second input device is operated to effect a change in the volume of the sound output by the first speaker.

4. The audio system of claim 1, further comprising a plurality of the first speakers and a plurality of the second speakers, and wherein the volume of the sound output by each of the first speakers can be changed together, and the volume of the sound output by each of the second speakers can be changed together.

5. The audio system of claim 1, wherein the low portion of the second frequency range is below the first frequency range.

6. The audio system of claim 1, wherein the first frequency range is defined by a first low limit and a first high limit and the second frequency range is defined by a second low limit and a second high limit, and the second low limit is lower than the first low limit.

7. The audio system of claim 1, wherein the first frequency range is coincident with the second frequency range.

8. An audio system for a vehicle, comprising:
a first speaker operable to output sound over a first frequency range;
a second speaker operable to output sound over a second frequency range;
a volume control selector operable to select a volume of the sound output by the first and second speakers;
a fade control selector operable to facilitate a change in the volume of the sound output by either one of the speakers independently of the volume of the sound output by the other one of the speakers; and
a filter disposed between the fade control selector and the second speaker, the filter being configured to maintain the volume of the sound output by the second speaker substantially constant over a low portion of the second frequency range, and to facilitate a reduction in the volume of the sound output by the second speaker over a high portion of the second frequency range, when the fade control selector is operated to facilitate a reduction in the volume of the sound output by the second speaker.

9. The audio system of claim 8, wherein the first speaker is disposed in a front portion of a vehicle, and the second speaker is disposed in a rear portion of the vehicle, and wherein the first frequency range has an upper limit higher than an upper limit of the second frequency range, and the second frequency range has a lower limit lower than a lower limit of the first frequency range.

10. The audio system of claim 9, further comprising:
a plurality of the first speakers disposed in the front portion of the vehicle; and
a plurality of the second speakers disposed in the rear portion of the vehicle, and
wherein the fade control selector operates on the sound output by each of the first speakers together, and the volume of the sound output by each of the second speakers together.

11. The audio system of claim 10, the vehicle including a trim component, and wherein at least one of the speakers is disposed in the vehicle trim component.

12. The audio system of claim 8, wherein the low portion of the second frequency range is below the first frequency range.

13. The audio system of claim 12, wherein the low portion of the second frequency range includes only frequencies below 80 Hertz.

14. The audio system of claim 8, wherein the fade control selector is operable to effect a change in the volume of the sound output by the first speaker over the entire first frequency range.

15. A method for controlling sound output by an audio system having first and second speakers, the first speaker being operable to output sound over a first frequency range, and the second speaker being operable to output sound over a second frequency range, the method comprising:
setting a volume of the sound output by the first speaker;
setting a volume of the sound output by the second speaker; and
changing the volume of the sound output by the second speaker independently of the volume of the sound output by the first speaker, such that the volume of the sound output by the second speaker over a high portion of the second frequency range is changed, while the volume of the sound output by the second speaker over a low portion of the second frequency range is held substantially constant.

16. The method of claim 15, wherein the low portion of the second frequency range includes only frequencies below 80 Hertz.

17. The method of claim 15, further comprising reducing the volume of the sound output by the first speaker over the first frequency range.

18. The method of claim 15, the audio system including a first input device, wherein the first input device is operated to set the volume of the sound output by the first and second speakers.

19. The method of claim 18, the audio system further including a second input device, wherein the second input device is operated to change the volume of the sound output by the second speaker independently of the volume of the sound output by the first speaker.

20. The method of claim 19, wherein the first input device includes a volume control selector and the second input device includes a fade control selector.
